(19) United States
(12) Patent Application Publication
(10) Pub. No.: US 2025/0042646 A1
(43) Pub. Date: Feb. 6, 2025

(54) Drink-Attachable Mixer Dispensing Device

(71) Applicant: Zachary Burgy, Akron, OH (US)

(72) Inventor: Zachary Burgy, Akron, OH (US)

(21) Appl. No.: 18/390,915

(22) Filed: Dec. 20, 2023

Related U.S. Application Data
(60) Provisional application No. 63/529,799, filed on Jul. 31, 2023.

(51) Int. Cl. B65D 85/804; B01F 23/45; B01F 33/501; B01F 35/71; B65D 1/02; B65D 41/04; B65D 51/18; B65D 51/28

(52) U.S. Cl. CPC B65D 85/804; B01F 23/45; B01F 33/50111; B01F 35/7131; B01F 35/7161; B65D 1/0246; B65D 41/0442; B65D 51/18; B65D 51/28; B01F 2101/14; B01F 2101/16; B65D 2251/205

(57) ABSTRACT

A drink-attachable mixer dispensing device is provided. The device is comprised of a bottle-attachable adapter and reservoir. The reservoir may house a first liquid that can be mixed with a second liquid within the bottle. After attaching the reservoir to the adapter and attaching the adapter to the bottle, the reservoir can be raised to allow the first liquid to escape the reservoir and adapter and mix with the second liquid within the bottle.

### CROSS-REFERENCE TO RELATED APPLICATION

The present application claims priority to, and the benefit of, U.S. Provisional Application No. 63/529,799, which was filed on Jul. 31, 2023, and is incorporated herein by reference in its entirety.

### FIELD OF THE INVENTION

The present invention relates generally to the field of beverages. More specifically, the present invention relates to a drink-attachable mixer dispensing device that can be attached to a bottle of a first liquid, wherein the device dispenses a second liquid into the bottle to create a mixed drink. Accordingly, the present disclosure makes specific reference thereto. Nonetheless, it is to be appreciated that aspects of the present invention are also equally applicable to other like applications, devices, and methods of manufacture.

### BACKGROUND

Many individuals enjoy mixed alcoholic or non-alcoholic drinks. However, the process of creating a mixed drink often involves a significant inconvenience wherein the mixer needs to be stored separately from the primary alcoholic beverage. This presents a challenge, particularly in large-scale venues such as stadiums, concert arenas, bars, and similar settings. In these environments, it becomes cumbersome and impractical for individuals to create their own mixed drinks as said individuals are faced with the hassle of handling two distinct bottles—one containing the alcohol and the other the mixer. This situation complicates the drink-making process, detracting from the enjoyment and convenience that is expected in such social settings.

Therefore, there exists a long-felt need in the art for a device that aids a user in making a mixed drink. More specifically, there exists a long-felt need in the art for a drink-attachable mixer dispensing device that may attach to a non-alcoholic drink and that holds an alcoholic mixer. Further, there exists a long-felt need in the art for a drink-attachable mixer dispensing device that allows a user to easily create a mixed drink without requiring a second mixer bottle that is separate from the primary drink bottle.

The subject matter disclosed and claimed herein, in one embodiment thereof, comprises a drink-attachable mixer dispensing device. The device is comprised of a bottle-attachable adapter and reservoir. The reservoir may house a first liquid that can be mixed with a second liquid within the bottle. After attaching the reservoir to the adapter and attaching the adapter to the bottle, the reservoir can be raised to allow the first liquid to escape the reservoir and adapter and mix with the second liquid within the bottle.

In this manner, the drink-attachable mixer dispensing device of the present invention accomplishes all the forgoing objectives and provides a device that aids a user in making a mixed drink that may attach to a non-alcoholic drink and that also holds an alcoholic mixer. Further, the device allows a user to easily create a mixed drink without requiring a second mixer bottle that is separate from the primary drink bottle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drink-attachable mixer dispensing device comprised of an adapter that attaches to a bottle and at least one reservoir received by the adapter. The reservoir houses a first liquid that can be released into the second liquid (stored within the bottle) to create a mixed drink. Both or either liquids may be any alcoholic or non-alcoholic liquid known in the art.

In one embodiment, the adapter is removably attached to the bottle and is comprised of a first end with at least one fastener that engages the threads of the bottle. The adapter is also comprised of a body that is positioned within the bottle (via the opening of the bottle) when the adapter is attached to the bottle, wherein the body receives the reservoir.

The reservoir is comprised of a body that is received by the adapter. The reservoir can be secured to at least one secondary fastener of the adapter via at least one cap positioned generally at the first end of the body of the reservoir. The cap is comprised of at least one male/female thread that engages the fastener of the adapter.

The second end of the body is received by the body of the adapter within the bottle. More specifically, the second end is comprised of at least one opening. When fully seated within the body, the opening is sealed by the bottom wall of the body, which may be indented/raised to provide a proper liquid-proof seal around the opening. In one embodiment, the opening is comprised of a removable seal that can be removed. The body is then comprised of at least one opening (that may be any shape and may be in any position on the body) that allows a first liquid within the reservoir to be mixed with the second liquid within the bottle when the cap is unscrewed from the adapter and the reservoir is pulled upwards such that the seal around the opening is broken and the first liquid flows through the opening in the body.

The present invention is also comprised of a method of using the device. First, a device is provided comprised of a bottle comprised of an opening and at least one thread; an adapter that attaches to the bottle, the adapter comprised of a body comprised of at least one opening, a first fastener, and a secondary fastener; a reservoir; and a cap. Then, the reservoir can be positioned such that the first end is the lowest point of the reservoir and the reservoir can be filled with a first liquid. Then, the adapter can be positioned around the reservoir such that the bottom wall of the body of the adapter seals the opening of the reservoir can secures the liquid within the reservoir and the cap can be secured to the secondary fastener. Next, the bottle can be filled with a second liquid. Next, the adapter can be attached to the bottle (wherein the body of the adapter is positioned within the bottle) via the fastener which engages the threads of the bottle after at least one sealing ring is placed around the threads, fastener, and/or opening. Next, when a user desires to mix the liquids the cap can be unfastened from the secondary fastener of the adapter such that the reservoir can be pulled upward from the adapter body such that the seal around the opening is broken and the liquid from the reservoir is released into the liquid of the bottle via the opening in the adapter body. Finally, a user can mix the liquids within the bottle as desired and drink the mixture from the bottle via the adapter or directly from the bottle after removing the adapter from the bottle.

Accordingly, the drink-attachable mixer dispensing device of the present invention is particularly advantageous as it provides a device that aids a user in making a mixed drink that may attach to a non-alcoholic drink and that also holds an alcoholic mixer. Further, the device allows a user to easily create a mixed drink without requiring a second mixer bottle that is separate from the primary drink bottle. In this manner, the drink-attachable mixer dispensing device provides a solution to easily making mixed drinks in a variety of settings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a drink-attachable mixer dispensing device of the present invention in accordance with the disclosed architecture;

FIG. 2 illustrates a side cross-sectional view of one potential embodiment of a drink-attachable mixer dispensing device of the present invention in accordance with the disclosed architecture;

FIG. 3 illustrates a perspective exploded view of one potential embodiment of a drink-attachable mixer dispensing device of the present invention in accordance with the disclosed architecture; and

FIG. 4 illustrates a flowchart of a method of using one potential embodiment of a drink-attachable mixer dispensing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that aids a user in making a mixed drink. More specifically, there exists a long-felt need in the art for a drink-attachable mixer dispensing device that may attach to a non-alcoholic drink and that holds an alcoholic mixer. Further, there exists a long-felt need in the art for a drink-attachable mixer dispensing device that allows a user to easily create a mixed drink without requiring a second mixer bottle that is separate from the primary drink bottle.

The present invention, in one exemplary embodiment, is comprised of a drink-attachable mixer dispensing device. The device is comprised of an adapter that attaches to a bottle and at least one reservoir received by the adapter, and wherein the reservoir houses a first liquid that can be released into the second liquid (stored within the bottle) to create a mixed drink. Both or either liquids may be any alcoholic or non-alcoholic liquid known in the art.

In one embodiment, the adapter is removably attached to the bottle and is comprised of a first end with at least one fastener that engages the threads of the bottle. The adapter is also comprised of a body that is positioned within the bottle (via the opening of the bottle) when the adapter is attached to the bottle, wherein the body receives the reservoir.

The reservoir is comprised of a body that is received by the adapter, wherein the reservoir can be secured to at least one secondary fastener of the adapter via at least one cap positioned generally at the first end of the body of the reservoir. The cap is comprised of at least one male/female thread that engages the fastener of the adapter.

The second end of the body is received by the body of the adapter within the bottle. More specifically, the second end is comprised of at least one opening. When fully seated within the body, the opening is sealed by the bottom wall of the body, which may be indented/raised to provide a proper liquid-proof seal around the opening. In one embodiment, the opening is comprised of a removable seal that can be removed. The body is then comprised of at least one opening (that may be any shape and may be in any position on the body) that allows a first liquid within the reservoir to be mixed with the second liquid within the bottle when the cap is unscrewed from the adapter and the reservoir is pulled upwards such that the seal around the opening is broken and the first liquid flows through the opening in the body.

The present invention is also comprised of a method of using the device. First, a device is provided comprised of a bottle comprised of an opening and at least one thread; an adapter that attaches to the bottle, the adapter comprised of a body comprised of at least one opening, a first fastener, and a secondary fastener; a reservoir; and a cap. Then, the reservoir can be positioned such that the first end is the lowest point of the reservoir and the reservoir can be filled with a first liquid. Then, the adapter can be positioned around the reservoir such that the bottom wall of the body of the adapter seals the opening of the reservoir can secures the liquid within the reservoir and the cap can be secured to the secondary fastener. Next, the bottle can be filled with a second liquid. Next, the adapter can be attached to the bottle (wherein the body of the adapter is positioned within the bottle) via the fastener which engages the threads of the bottle after at least one sealing ring is placed around the threads, fastener, and/or opening. Next, when a user desires to mix the liquids the cap can be unfastened from the secondary fastener of the adapter such that the reservoir can be pulled upward from the adapter body such that the seal around the opening is broken and the liquid from the reservoir is released into the liquid of the bottle via the opening in the adapter body. Finally, a user can mix the liquids within the bottle as desired and drink the mixture from the bottle via the adapter or directly from the bottle after removing the adapter from the bottle.

Accordingly, the drink-attachable mixer dispensing device of the present invention is particularly advantageous as it provides a device that aids a user in making a mixed drink that may attach to a non-alcoholic drink and that also holds an alcoholic mixer. Further, the device allows a user to easily create a mixed drink without requiring a second mixer bottle that is separate from the primary drink bottle. In this manner, the drink-attachable mixer dispensing device provides a solution to easily making mixed drinks in a variety of settings.

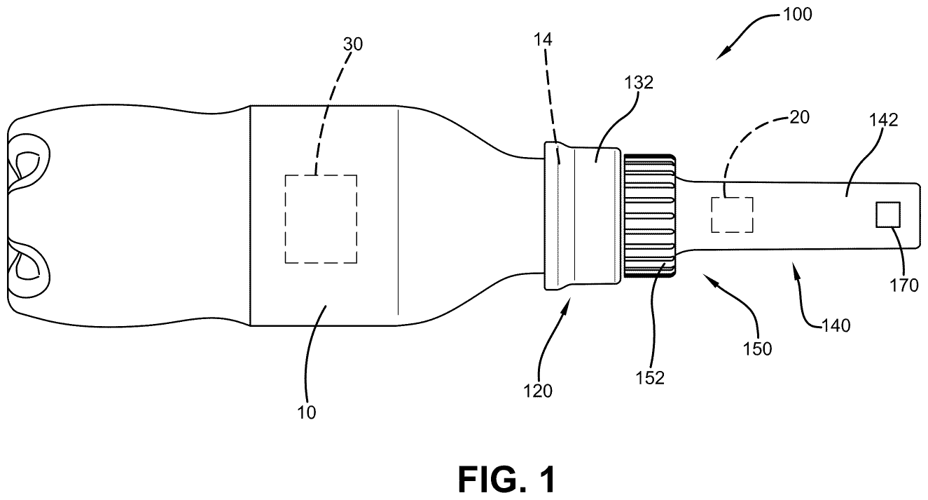

Referring initially to the drawings, FIG. 1 illustrates a side view of one potential embodiment of a drink-attachable mixer dispensing device 100 of the present invention in accordance with the disclosed architecture. The device 100 is comprised of an adapter 120 that attaches to a bottle 10 and at least one reservoir 140 received by the adapter 120. The reservoir 140 houses a first liquid 20 that can be released into the second liquid 30 (stored within the bottle 10) to create a mixed drink. It should be noted that both or either liquids 20,30 may be any alcoholic or non-alcoholic liquid known in the art.

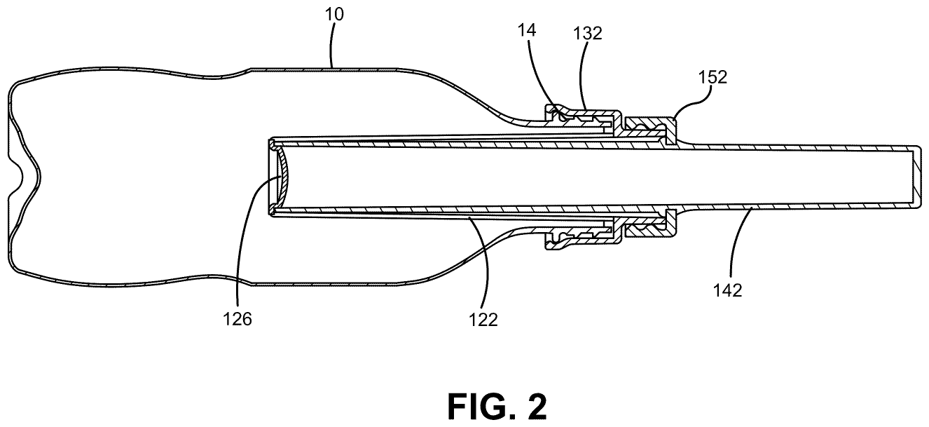

The adapter 120 attaches to a bottle 10 during use. The bottle 10 may be any drink bottle/holding vessel of any type of any material, size, and configuration. In one embodiment, the adapter 120 is fixedly attached to the bottle 10. In a second embodiment, the adapter 120 is removably attached to the bottle. In this embodiment, the adapter 120 is comprised of a first end 130 with at least one fastener 134 that engages the threads 14 of the bottle 10, as seen in FIG. 2. In another embodiment, the adapter 120 snaps on to the bottle 10 and/or bottle neck ring. The fastener 134 is preferably but not limited to male or female threads. The fastener 134 is concealed via a thread cover body 132 of the adapter 120. In this embodiment, the device 100 may also be comprised of at least one sealing ring 110 (of any type of liquid-proof ring known in the art) that is positioned around/between both sets of threads 14,134 and/or around the opening 12 of the bottle 10. In one embodiment, the sealing ring 110 may be incorporated directly into the adapter 120 (or any other part of the device 100). The adapter 120 is also comprised of a body 122 that is positioned within the bottle 10 (via the opening 12 of the bottle 10) when the adapter 120 is attached to the bottle 10. The body 122 receives the reservoir 140.

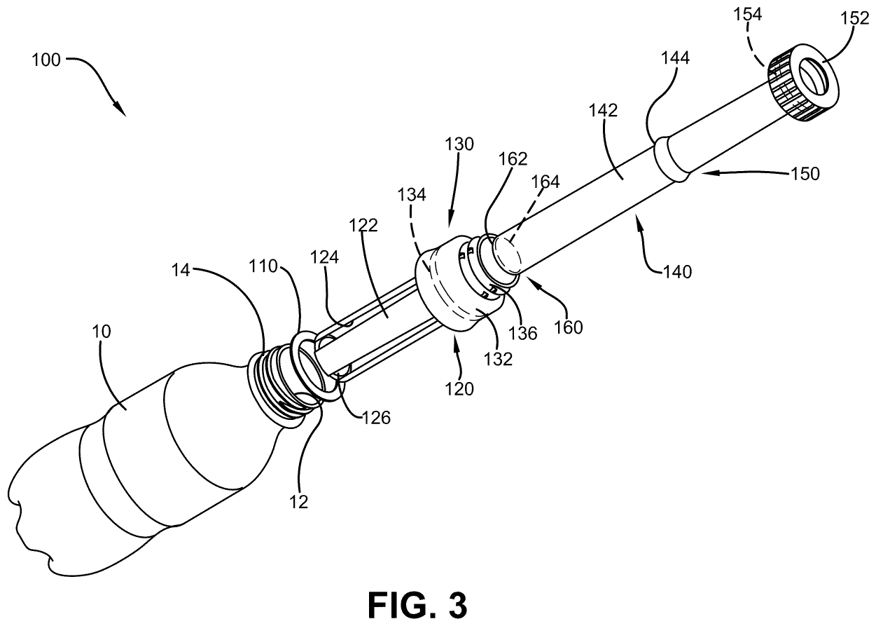

The reservoir 140 is comprised of a body 142 that is preferably cylindrical, although the body 142 may be any shape in different embodiments. The reservoir 140 is received by the adapter 120. The reservoir 140 can be secured to at least one secondary fastener 136 (such as but not limited to male or female threads) of the adapter 120 via at least one cap 152 positioned generally at the first end 150 of the body 142 of the reservoir 140. The cap 152 is comprised of at least one male/female thread 154 that engages the fastener 136 of the adapter 120. The position of the cap 152 around the body 142 is stopped at a specific position via at least one raised stopper ring 144, as seen in FIG. 3. In this manner, the reservoir 140 can be secured to/within the adapter 120 by screwing the cap 152 onto the adapter 120.

The second end 160 of the body 142 is received by the body 122 of the adapter 120 within the bottle 10. More specifically, the second end 160 is comprised of at least one opening 162. When fully seated within the body 122, the opening 162 is sealed by the bottom wall 126 of the body 122, which may be indented/raised to provide a proper liquid-proof seal around the opening 162. In one embodiment, the opening 162 is comprised of a removable seal 164 that can be removed. The body 122 is then comprised of at least one opening 124 (that may be any shape and may be in any position on the body 122) that allows a first liquid 20 within the reservoir 140 to be mixed with the second liquid 30 within the bottle 10 when the cap 152 is unscrewed from the adapter 120 and the reservoir 140 is pulled upwards such that the seal around the opening 162 is broken and the first liquid 20 flows through the opening 124 in the body 122.

In one embodiment, the reservoir 140 may be comprised of a decorative element 170 such as but not limited to a 2D or 3D pattern, logo, symbol, word, number, etc. The bottle 10 may also be comprised of the same element 170.

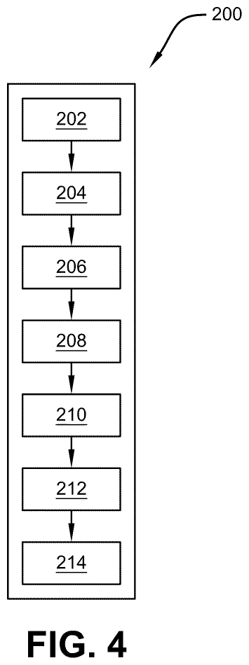

The present invention is also comprised of a method of using 200 the device 100, as seen in FIG. 4. First, a device 100 is provided comprised of a bottle 10 comprised of an opening 12 and at least one thread 14; an adapter 120 that attaches to the bottle 10, the adapter 120 comprised of a body 122 comprised of at least one opening 124, a first fastener 134, and a secondary fastener 136; a reservoir 140; and a cap 152 [Step 202]. Then, the reservoir 140 can be positioned such that the first end 150 is the lowest point of the reservoir 140 and the reservoir 140 can be filled with a first liquid 20 that may be any liquid type known in the art [Step 204]. Then, the adapter 120 can be positioned around the reservoir 140 such that the bottom wall 126 of the body 122 of the adapter 120 seals the opening 162 of the reservoir 140 can secures the liquid 20 within the reservoir 140 and the cap 152 can be secured to the secondary fastener 136 [Step 206]. Next, the bottle 10 can be filled with a second liquid 30 [Step 208]. Next, the adapter 120 can be attached to the bottle 10 (wherein the body 122 of the adapter 120 is positioned within the bottle 10) via the fastener 134 which engages the threads 14 of the bottle 10 after at least one sealing ring 110 is placed around the threads 14, fastener 134, and/or opening 12 [Step 210]. Next, when a user desires to mix the liquids 20,30 the cap 152 can be unfastened from the secondary fastener 136 of the adapter 120 such that the reservoir 140 can be pulled upward from the adapter 120 body 122 such that the seal around the opening 162 is broken and the liquid 20 from the reservoir 140 is released into the liquid 30 of the bottle 10 via the opening 124 in the adapter 120 body 122 [Step 212]. Finally, a user can mix the liquids 20,30 within the bottle 10 as desired and drink the mixture from the bottle 10 via the adapter 120 or directly from the bottle 10 after removing the adapter 120 from the bottle 10 [Step 214]. In one embodiment, the adapter 120 may not be removable from the bottle 10.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drink-attachable mixer dispensing device” and “device” are interchangeable and refer to the drink-attachable mixer dispensing device 100 of the present invention.

Notwithstanding the forgoing, the drink-attachable mixer dispensing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the drink-attachable mixer dispensing device 100 as shown in the FIGS. are for illustrative purposes only, and that many other sizes and shapes of the drink-attachable mixer dispensing device 100 are well within the scope of the present disclosure. Although the dimensions of the drink-attachable mixer dispensing device 100 are important design parameters for user convenience, the drink-attachable mixer dispensing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drink-attachable mixer dispensing device comprising:
a reservoir comprised of a stopping ring, a cap comprised of a first thread, and a first opening; and
an adapter comprised of a first body comprised of a second opening and a bottom wall, a second thread, and a third thread.

2. The drink-attachable mixer dispensing device of claim 1, wherein the first thread of the cap attaches to the third thread.

3. The drink-attachable mixer dispensing device of claim 1, wherein the second thread attaches to a fourth thread of a bottle.

4. The drink-attachable mixer dispensing device of claim 1, wherein the first opening is comprised of a removable seal.

5. The drink-attachable mixer dispensing device of claim 1 comprised of a sealing ring.

6. A drink-attachable mixer dispensing device comprising:
a reservoir comprised of a stopping ring, a cap comprised of a first thread, and a first opening;
an adapter comprised of a first body comprised of a second opening and a bottom wall, a second thread, and a third thread; and
a bottle comprised of a third opening and a fourth thread.

7. The drink-attachable mixer dispensing device of claim 6, wherein the first thread of the cap attaches to the third thread.

8. The drink-attachable mixer dispensing device of claim 6, wherein the second thread attaches to the fourth thread.

9. The drink-attachable mixer dispensing device of claim 6, wherein the first opening is comprised of a removable seal.

10. The drink-attachable mixer dispensing device of claim 9, wherein the reservoir is comprised of a first liquid.

11. The drink-attachable mixer dispensing device of claim 9, wherein the bottle is comprised of a second liquid.

12. The drink-attachable mixer dispensing device of claim 6 comprised of a sealing ring.

13. A method of using a drink-attachable mixer dispensing device, the method comprising:
providing a drink-attachable mixer dispensing device comprised of a bottle comprised of a first opening and a thread, an adapter comprised of a first fastener, a second fastener, and a body comprised of a second opening, wherein the adapter that attaches to the bottle, a reservoir, and a cap;
filling the reservoir with a first liquid;
positioning the adapter around the reservoir such that a bottom wall of the adapter form a seal around a third opening of the reservoir and securing the cap to the second fastener;
filling the bottle with a second liquid;
attaching the adapter to the bottle; and
unfastening the cap from the second fastener and pulling the reservoir upwards such that the seal is broken and the first liquid and the second liquid mix within the bottle.

14. The method of using a drink-attachable mixer dispensing device of claim 13, wherein the first fastener is comprised of a thread.

15. The method of using a drink-attachable mixer dispensing device of claim 13, wherein the second fastener is comprised of a thread.

16. The method of using a drink-attachable mixer dispensing device of claim 13, wherein the cap is comprised of a third fastener.

17. The method of using a drink-attachable mixer dispensing device of claim 16, wherein the third fastener is comprised of a thread.

18. The method of using a drink-attachable mixer dispensing device of claim 13, wherein the body of the adapter is positioned within the bottle.

19. The method of using a drink-attachable mixer dispensing device of claim 13, wherein the first liquid is comprised of an alcoholic liquid.

20. The method of using a drink-attachable mixer dispensing device of claim 13, wherein the first liquid is comprised of a non-alcoholic liquid.
